(19) United States
(12) Patent Application Publication
(10) Pub. No.: US 2024/0290199 A1
(43) Pub. Date: Aug. 29, 2024

(54) TRAFFIC MONITORING METHOD BASED ON AERIAL SURVEY DATA

(71) Applicant: SHENZHEN ZHUOYU TECHNOLOGY CO., LTD., Shenzhen (CN)

(72) Inventors: Yuxin ZHANG, Shenzhen (CN); Luyao WANG, Shenzhen (CN); Pengfei LI, Shenzhen (CN); Xinyi DU, Shenzhen (CN); Haitao MA, Shenzhen (CN); Quanyue CHENG, Shenzhen (CN); Xianliang WU, Shenzhen (CN)

(21) Appl. No.: 18/505,465

(22) Filed: Nov. 9, 2023

Related U.S. Application Data
(63) Continuation of application No. PCT/CN2021/096992, filed on May 28, 2021.

(51) Int. Cl. G08G 1/01; B64U 20/87

(52) U.S. Cl. CPC G08G 1/0108; B64U 20/87; G08G 1/0125; B64U 2201/20

(57) ABSTRACT

A data processing method includes obtaining location information of a target path, generating a control instruction according to the location information to instruct a mobile platform to move to above the target path, obtaining survey data of the target path collected by a sensor of the mobile platform and determining status information of one or more traffic participants on the target path based on the survey data, and marking a target data fragment in the survey data according to the status information of the one or more traffic participants. Status information of the one or more traffic participants in the target data fragment satisfies a preset status information condition.

### CROSS-REFERENCE TO RELATED APPLICATION

This application is a continuation of International Application No. PCT/CN2021/096992, filed May 28, 2021, the entire content of which is incorporated herein by reference.

### TECHNICAL FIELD

The present disclosure relates to the field of data processing and, more particularly, to a traffic monitoring method based on aerial survey data.

### BACKGROUND

With the continuous improvement of social science and technology, intelligent transportation and intelligent vehicles, especially the research on autonomous vehicles, have become hot research topics. During researching and developing of autonomous vehicles, there is a need to study actual traffic scenarios to conduct safety testing and verification of autonomous vehicles, such that autonomous vehicles can drive safely in actual traffic scenarios.

### SUMMARY

In accordance with the disclosure, there is provided a data processing method including obtaining location information of a target path, generating a control instruction according to the location information to instruct a mobile platform to move to above the target path, obtaining survey data of the target path collected by a sensor of the mobile platform and determining status information of one or more traffic participants on the target path based on the survey data, and marking a target data fragment in the survey data according to the status information of the one or more traffic participants. Status information of the one or more traffic participants in the target data fragment satisfies a preset status information condition.

### BRIEF DESCRIPTION OF THE DRAWINGS

FIG. 1 is a schematic diagram showing a scenario of a data processing method consistent with the present disclosure.

FIG. 2 is a schematic diagram showing a scenario in which an unmanned aerial vehicle collects survey data over a target road segment consistent with the present disclosure.

FIG. 3 is a flow chart of a data processing method consistent with the present disclosure.

FIG. 4 is a schematic diagram showing another scenario in which an unmanned aerial vehicle collects survey data over a target road segment consistent with the present disclosure.

FIG. 5 is a schematic diagram showing another scenario in which an unmanned aerial vehicle collects survey data over a target road segment consistent with the present disclosure.

FIG. 6 is a schematic diagram showing a scenario of a traffic incident with lane change and cut-in consistent with the present disclosure.

FIG. 7 is a schematic diagram showing a scenario of a traffic incident with front vehicle braking consistent with the present disclosure.

FIG. 8 is a schematic diagram showing a scenario of a traffic incident with lane change and cut-out consistent with the present disclosure.

FIG. 9 is a flow chart of an implementation of a data processing method consistent with the present disclosure.

FIG. 10 is a schematic diagram showing another scenario in which an unmanned aerial vehicle collects survey data over a target road segment consistent with the present disclosure.

FIG. 11 is a flow chart of an implementation of a data collection method consistent with the present disclosure.

FIG. 12 is a schematic structural diagram showing a ground control platform consistent with the present disclosure.

FIG. 13 is a schematic structural diagram of an unmanned aerial vehicle consistent with the present disclosure.

FIG. 14 is a schematic structural diagram of a data processing system consistent with the present disclosure.

### DETAILED DESCRIPTION OF THE EMBODIMENTS

The technical solutions of the present disclosure will be described below in conjunction with the drawings in the embodiments of the present disclosure. Obviously, the described embodiments are just some of the embodiments of the present disclosure, but not all of the embodiments. Based on the embodiments in this disclosure, all other embodiments obtained by those of ordinary skill in the art without creative work shall fall within the scope of this disclosure.

The flow charts shown in the drawings are just illustrations, and do not necessarily include all contents and operations/steps, nor must they be performed in the order described. For example, some operations/steps can be decomposed, combined or partly combined, so the actual order of execution may be changed according to the actual situation.

The embodiments of the present disclosure will be described below in conjunction with the drawings in the embodiments of the present disclosure. In the case of no conflict, the following embodiments and features in the embodiments may be combined with each other.

Test vehicles equipped with sensors can be used to drive on roads and record survey data collected by the sensing sensors. Alternatively, sensors can be installed on road infrastructure such as traffic lights, traffic signs, or street lights to collect data on a certain road segment on a fixed basis. However, survey data collected by the sensors on the test vehicles and the road infrastructure have limitations and low accuracy.

The present disclosure provides a traffic monitoring method based on survey data, such as aerial survey data, to at least partially alleviate the above problems. A data processing method presented by the present disclosure may use a mobile platform, such as an unmanned aerial vehicle, to move over a target path, such as a target road segment, and use sensors to collect survey data on each object on the target path. Based on the survey data collected by the mobile platform, traffic flows and environmental changes in the traffic scene may be monitored. The use of the mobile platform to collect data may greatly reduce the limitations of the survey data and improve the comprehensiveness and accuracy of the survey data. By marking a target data fragment in the survey data collected by the mobile platform and determining that the status information, such as movement information, of the traffic participants contained in the target data fragment satisfies status information conditions, such as movement information condition, the subsequent safety test of autonomous vehicles based on the marked target data fragment may be facilitated, improving the accuracy of the safety testing of the autonomous vehicles.

Hereinafter, some embodiments of the present disclosure are described using unmanned aerial vehicle(s) surveying a target road segment as an example. The methods, devices, and systems described below can be generally applied to the scenario where mobile platform(s) is used to survey a target path.

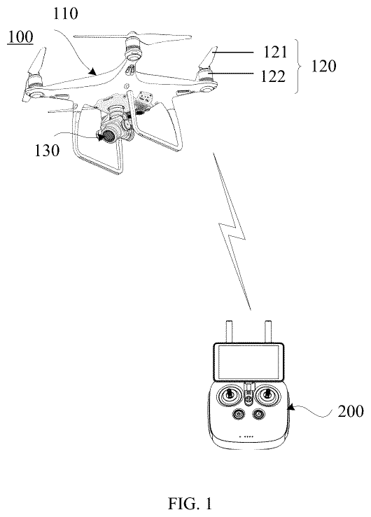

As shown in FIG. 1, which is a schematic diagram showing a scenario of a data processing method provided by one embodiment of the present disclosure, the scenario includes an unmanned aerial vehicle 100 and a ground control platform 200. The unmanned aerial vehicle 100 is connected through communication with the ground control platform 200 to realize data interaction between the unmanned aerial vehicle 100 and the ground control platform 200. The unmanned aerial vehicle 100 may be, for example, a four-rotor unmanned aerial vehicle, a six-rotor unmanned aerial vehicle, or an eight-rotor unmanned aerial vehicle. In some other embodiments, the unmanned aerial vehicle 100 may also be a fixed-wing unmanned aerial vehicle, or a combination of a rotary-wing unmanned aerial vehicle and a fixed-wing unmanned aerial vehicle, which is not limited here. The ground control platform 200 may include, but is not limited to, a desktop computer, a remote control, a tablet computer, a smart phone, or a server.

The unmanned aerial vehicle 100 includes a first wireless communication device, and the ground control platform 200 includes a second wireless communication device. Through the first wireless communication device and the second wireless communication device, the wireless communication link between the unmanned aerial vehicle 100 and the ground control platform 200 may be established. The first wireless communication device and the second wireless communication device may be private network wireless communication devices or public network wireless communication devices. The public network wireless communication devices may include but are not limited to 4G communication devices, 5G communication devices, or 6G communication devices. The private network wireless communication devices may include wireless communication devices based on software defined radio (SDR) such as Lightbridge or Ocusync.

In one embodiment, as shown in FIG. 1, the unmanned aerial vehicle 100 includes a body 110, a power system 120, a sensor 130 and a control system (not shown in FIG. 1). The power. system 120 and the sensor 130 may be disposed on the body 110, and the control system may be installed in the body 110. The power system 120 may be used to provide flight power for the unmanned aerial vehicle 100, the sensor 130 may be used to collect survey data, and the control system may be used to control the flight of the unmanned aerial vehicle 100. The sensor 130 may include an image acquisition device or a radar device. The image acquisition device may include a monocular camera or a multicular camera, and the radar device may include a millimeter wave radar or a laser radar.

In one embodiment, the power system 120 may include one or more propellers 121, one or more motors 122 corresponding to the one or more propellers 121, and one or more electronic speed regulators. Each motor 122 may be connected between one corresponding electronic speed regulator and one corresponding propeller 121. The one or more motors 122 and the one or more propellers 121 may be arranged on the body 110 of the unmanned aerial vehicle 100. Each electronic speed regulator may be used to receive a drive signal generated by the control system to provide a drive current according to the drive signal to one corresponding motor 122 to control the rotation speed of the corresponding motor 122, and the motor 122 may be used to drive the corresponding propeller 121 to rotate, thereby providing power for the flight of the unmanned aerial vehicle 100. The power may enable the unmanned aerial vehicle 100 to achieve movement with one or more degrees of freedom. In some embodiments, the unmanned aerial vehicle 100 may be able to rotate about one or more axes of rotation. For example, the above-mentioned rotation axis may include a roll axis, a yaw axis, or a pitch axis. It should be understood that the one or more motors 122 may include a DC motor or an AC motor. In addition, the one or more motors 122 may include a brushless motor or a brushed motor.

In one embodiment, the control system may include a controller and a sensing system. The sensing system may be used to measure the posture information and movement information of a movable platform, such as three-dimensional position, three-dimensional angle, three-dimensional velocity, three-dimensional acceleration, three-dimensional angular velocity, etc. The posture information may be the location information and attitude information of the unmanned aerial vehicle 100 in space. The sensing system may include, for example, at least one of a gyroscope, an ultrasonic sensor, an electronic compass, an inertial measurement unit (IMU), a vision sensor, a global navigation satellite system, a barometer, or another sensor. For example, the global navigation satellite system may be the global positioning system (GPS). The controller may be used to control the movement of the unmanned aerial vehicle 100. For example, the controller may control the movement of the unmanned aerial vehicle 100 based on the posture information measured by the sensing system. It should be understood that the controller may be able to automatically control the unmanned aerial vehicle 100 according to pre-programmed instructions.

In one embodiment, the ground control platform 200 may be communicatively connected to a display device. The display device may be used to display a human-computer interaction page. The user may select the road segment to be collected through the human-computer interaction page. It should be noted that the display device may include a display screen provided on the ground control platform 200 or a display screen independent of the ground control platform 200. The display screen independent of the ground control platform 200 may include a mobile phone, a tablet computer, a personal computer, or another electronic device with a display screen. The display screen may include an LED display screen, an OLED display screen, an LCD display screen, and so on.

In one embodiment, the ground control platform 200 may obtain the location information of the target road segment, generate an unmanned aerial vehicle control instruction based on the location information of the target road segment, and then send the unmanned aerial vehicle control instruction to the unmanned aerial vehicle 100. The unmanned aerial vehicle 100 may receive the unmanned aerial vehicle control instruction sent by the ground control platform 200, and fly over the target road segment according to the unmanned aerial vehicle control instruction. When the unmanned aerial vehicle 100 arrives above the target road segment, the survey data of the target road segment may be collected through the sensor 130 on the unmanned aerial vehicle 100 and then may be sent to the ground control platform 200. The ground control platform 200 may receive the survey data collected by the unmanned aerial vehicle 100, and determine the movement information of one or more traffic participants on the target road segment based on the survey data. The ground control platform 200 may also mark a target data fragment in the survey data according to the movement information of the one or more traffic participants. The movement information of the one or more traffic participants in the target data fragment may meet a preset movement information condition.

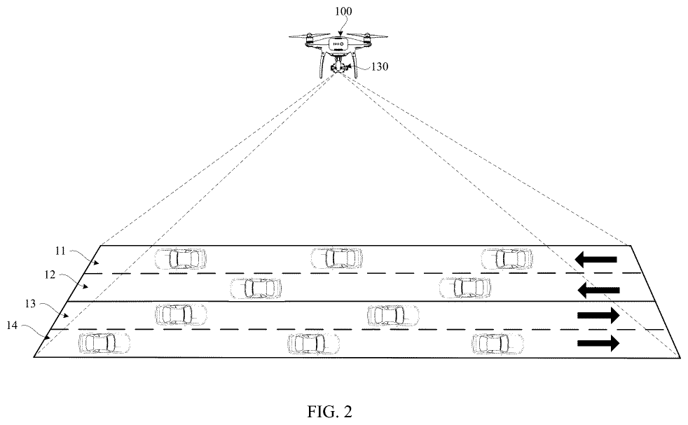

For example, in one embodiment, as shown in FIG. 2, the unmanned aerial vehicle 100 is located over the target road segment, and the target road segment includes a first lane 11, a second lane 12, a third lane 13 and a fourth lane 14. The driving directions of the vehicles indicated by the first lane 11 and the second lane 12 are the same, the driving directions of the vehicles indicated by the third lane 13 and the fourth lane 14 are the same, and the driving directions of the vehicles indicated by the first lane 11 and the third lane 13 are different. The unmanned aerial vehicle 100 may collect the survey data of the first lane 11, the second lane 12, the third lane 13, and the fourth lane 14 through the sensor 130.

The data processing method provided by one embodiment of the present disclosure will be described below in conjunction with the scenario in FIG. 1. For description purposes only, the scenario in FIG. 1 is used as an example to illustrate the data processing method provided by the present disclosure, and does not limit the scope of the application scenarios of the data processing method provided by the present disclosure.

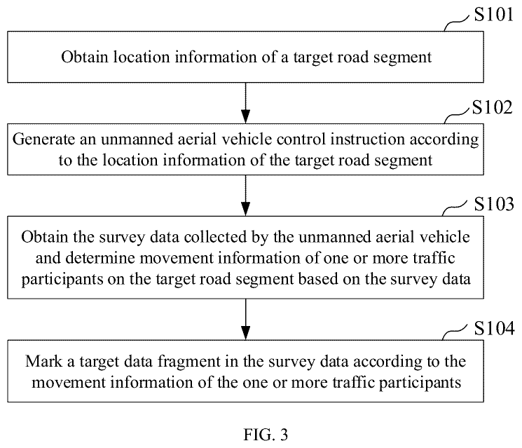

FIG. 3 is a flow chart of the data processing method provided by one embodiment of the present disclosure. The data processing method may be applied to the ground control platform.

As shown in FIG. 3, in one embodiment, the data processing method includes S101 to S104.

At S101, the location information of the target road segment is obtained.

The location information of the target road segment may be determined based on the user's operation on the human-computer interaction page of the ground control platform.

In one embodiment, the ground control platform may display a road segment selection page. The road segment selection page may include a map. A road segment starting point and a road segment end point selected by the user in the map may be obtained. Based on the road segment starting point and the road segment end point, the target road segment to be collected and the location information of the target road segment may be obtained. The map may include a city map of a city where the ground control platform is located. The road segment selection page may allow the user to quickly select the target road segment to collect data.

In one embodiment, for example, the location information of the target road segment may include the first longitude and latitude of the starting point of the road segment, the second longitude and latitude of the end point of the road segment, and the longitude and latitude between the first longitude and latitude and the second longitude and latitude. The first latitude and longitude of the starting point of the target road segment may be determined based on the coordinates of the starting point of the road segment in the map, and the second latitude and longitude of the end point of the target road segment may be determined based on the coordinates of the end point of the road segment in the map.

In one embodiment, for example, the current location information of the ground control platform may be obtained and the city code of the city where the ground control platform is currently located may be obtained based on the current location information of the ground control platform. Then, the road segment selection page based on the determined city code may be displayed. The map in the road segment selection page may be related to the city code.

At S102, the unmanned aerial vehicle control instruction is generated based on the location information of the target road segment.

The unmanned aerial vehicle control instruction may be used to instruct the unmanned aerial vehicle to fly over the target road segment such that the sensor mounted at the unmanned aerial vehicle collects the survey data of the target road segment. The sensor carried by the unmanned aerial vehicle may include an image acquisition device or a radar device. The image acquisition device may include a monocular camera or a multicular camera, and the radar device may include a millimeter wave radar or a laser radar.

In one embodiment, the unmanned aerial vehicle control instruction may be also used to instruct the unmanned aerial vehicle to hover over the target road segment and/or fly over the target road segment at a preset flight speed. The preset flight speed may be set based on actual conditions or set by the user. This is not specifically limited in the embodiments of the present disclosure. By hovering the unmanned aerial vehicle over the target road segment, fixed-point collection of the survey data on the target road segment may be achieved. The power consumption of the unmanned aerial vehicle may also be reduced, and the endurance of the unmanned aerial vehicle may be improved. By controlling the unmanned aerial vehicle to fly over the target road segment according to the preset flight speed, the unmanned aerial vehicle may collect the survey data covering the entire target road segment, thereby collecting more comprehensive survey data.

In one embodiment, the control system of the unmanned aerial vehicle may obtain the hovering height in the unmanned aerial vehicle control instruction when the unmanned aerial vehicle arrives above the target road segment; and then control the unmanned aerial vehicle to hover over the target road segment according to the hovering height. The hovering height may be determined based on the height of the traffic participants in the target road segment and the preset safe height. The preset safe height may be set based on the actual situation or set by the user, which is not limited in the present disclosure.

In one embodiment, when the unmanned aerial vehicle arrives above the target road segment, the control system of the unmanned aerial vehicle may obtain the flight speed in the unmanned aerial vehicle control instruction; and then control the unmanned aerial vehicle to fly over the target road segment according to the flight speed. When the unmanned aerial vehicle flies over the target road segment at the flight speed, the distance between the unmanned aerial vehicle and the target road segment may remain roughly unchanged. That is, when the unmanned aerial vehicle flies over the target road segment at the flight speed, the change of the distance between the unmanned aerial vehicle and the target road segment may be less than or equal to a preset change threshold. The preset change threshold may be set based on the actual situation, and this is not specifically limited in the present disclosure.

In one embodiment, the unmanned aerial vehicle control instruction may be used to instruct the unmanned aerial vehicle to fly over the target road segment within a preset time period, such that the sensor on the unmanned aerial vehicle collects the survey data of the target road segment within the time period. By controlling the unmanned aerial vehicle to fly over the target road segment within the set time period to collect the survey data of the target road segment within the set time period, the collection of the survey data in the specific time period may be achieved.

In one embodiment, the control system of the unmanned aerial vehicle may obtain a time period for the unmanned aerial vehicle to collect data in the unmanned aerial vehicle control instruction; and then control the unmanned aerial vehicle to fly over the target road segment within the time period, such that the sensor on the unmanned aerial vehicle collects the survey data of the target road segment within the time period. The time period may be set based on the actual situation or set by the user, which is not limited in the present disclosure.

In one embodiment, the unmanned aerial vehicle control instruction may be also used to instruct the unmanned aerial vehicle to fly over the target road segment in the same or opposite direction as the movement direction of the traffic participants on the target road segment. The survey data of the target road segment collected by the unmanned aerial vehicle flying over the target road segment in the same direction as the movement direction of the traffic participants on the target road segment may record the forward or backward correlation of the traffic participants in the long-range road segment. When the unmanned aerial vehicle flies over the target road segment in the opposite direction to the movement direction of the traffic participants on the target road segment, the survey data may be collected faster.

For example, the control system of the unmanned aerial vehicle may determine the movement direction of the traffic participants on the target road segment based on the survey data, and then control the unmanned aerial vehicle to fly in the same or opposite direction to the movement direction of the traffic participants. For example, the method of determining the movement direction of the traffic participants on the target road segment based on the survey data may include: determining the traffic participants in each frame of the survey data, determining the location information of the traffic participants at different times based on each frame of the survey data, and determining the movement direction of the traffic participants on the target road segment based on the location information of the traffic participants at different times. The traffic participants may include dynamic objects or static objects that have an impact on vehicle driving decisions. The traffic participants may include other mobile platforms (such as motor vehicles or non-motor vehicles), pedestrians, or animals.

In one embodiment, the unmanned aerial vehicle control instruction may be used to instruct a plurality of unmanned aerial vehicles to fly over the target road segment, such that sensors carried by the plurality of unmanned aerial vehicles collect the survey data of the target road segment. The survey data collected by the plurality of unmanned aerial vehicles may be spliced based on the time dimension and/or position dimension. By controlling the plurality of unmanned aerial vehicles to fly over the target road segment, the sensors carried by the plurality of unmanned aerial vehicles may be able to simultaneously collect the survey data of the target road segment, and the ground control platform may obtain the survey data of the target road segment collected by the plurality of unmanned aerial vehicles to splice the survey data of the target road segment to obtain more comprehensive survey data.

For example, in one embodiment, the unmanned aerial vehicle control instruction may be used to instruct the plurality of unmanned aerial vehicles to fly to different locations over the target road segment and hover, such that the sensors carried by the plurality of unmanned aerial vehicles collect the survey data of the target road segment at different locations. By controlling the plurality of unmanned aerial vehicles to fly to different positions over the target road segment and hover, the sensors carried by the plurality of unmanned aerial vehicles may be able to simultaneously collect the survey data of the target road segment. The ground control platform may obtain the survey data of the target road segment collected by the plurality of unmanned aerial vehicles and splice the survey data of the target road segment based on the position dimension to obtain more comprehensive survey data.

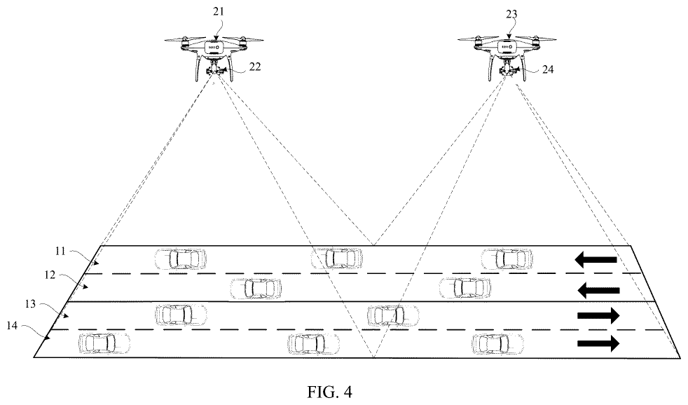

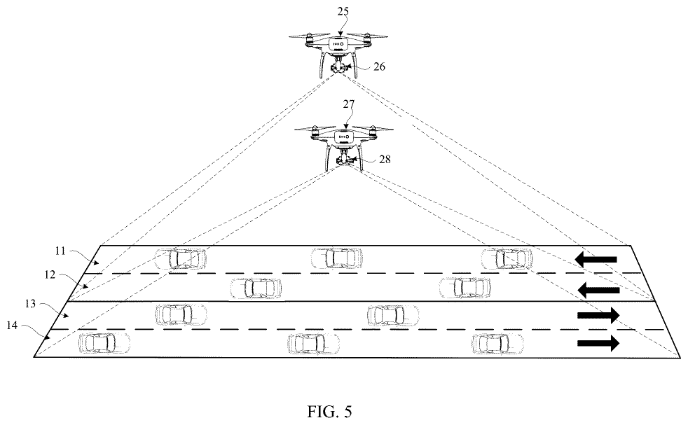

In one embodiment shown in FIG. 4, an unmanned aerial vehicle 21 and an unmanned aerial vehicle 23 are hovering over the target road segment, and the positions of the unmanned aerial vehicle 21 and the unmanned aerial vehicle 23 are different. The unmanned aerial vehicle 21 collects the survey data of the left segment area of the target road segment through a sensor 22, and the unmanned aerial vehicle 23 collects the survey data of the right segment area of the target road. As shown in FIG. 5, an unmanned aerial vehicle 25 hovers over a first lane 11 and a second lane 12 of the target road segment, and collects the survey data of the first lane 11 and the second lane 12 through a sensor 26. An unmanned aerial vehicle 27 hovers over a third lane 13 and a second lane 14 of the target road segment, and collects the survey data of the third lane 13 and the second lane 14 through a sensor 28.

In one embodiment, the unmanned aerial vehicle control instruction may be used to instruct the plurality of unmanned aerial vehicles to fly over the target road segment at different time periods, such that the sensors carried by the plurality of unmanned aerial vehicles collect the survey data of the target road segment at different time periods. By controlling the plurality of unmanned aerial vehicles to fly over the target road segment at different time periods, the sensors carried by the plurality of unmanned aerial vehicles may be able to collect the survey data of the target road segment at different time periods. The ground control platform may obtain the survey data of the target road segment collected by the plurality of unmanned aerial vehicles and splice the survey data of the target road segment based on the time dimension to obtain more comprehensive survey data.

In one embodiment, the plurality of unmanned aerial vehicles may include a first unmanned aerial vehicle and a second unmanned aerial vehicle, and the unmanned aerial vehicle control instruction may be used to instruct the first unmanned aerial vehicle to fly over the target road segment and fly in the same direction as the movement direction of the traffic participants on the target road segment. The unmanned aerial vehicle control instruction may be also used to instruct the second unmanned aerial vehicle to fly over the target road segment and fly in the opposite direction to the movement direction of the traffic participants on the target road segment. Flight trajectories of the first unmanned aerial vehicle and the second unmanned aerial vehicle may not intersect.

In one embodiment, when the unmanned aerial vehicle arrives above the target road segment, the control system of the unmanned aerial vehicle may adjust the sensing direction of the sensor such that the sensing direction of the sensor faces the target road segment. The sensor may be coupled and mounted at a gimbal of the unmanned aerial vehicle, and the gimbal may be used to adjust the sensing direction of the sensor. By adjusting the sensing direction of the sensor such that the sensing direction of the sensor faces the target road segment, the sensor may be able to collect the survey data of the target road segment from a better perspective, improving the accuracy of the survey data.

In one embodiment, the control system of the unmanned aerial vehicle may predict a target area where a preset traffic event will occur on the target road segment based on the survey data; and then control the unmanned aerial vehicle to be located over the target area based on the location information of the target area. The preset traffic event may be defined by the movement information of one or more traffic participants. The preset traffic event may be defined and set by the user. This is not specifically limited in the embodiments of the present disclosure. By predicting the target area where the preset traffic event will occur on the target road segment and controlling the unmanned aerial vehicle to be located over the target area, the survey data containing preset traffic data may be collected faster.

In one embodiment, the control system of the unmanned aerial vehicle may determine the movement information of one or more traffic participants on the target road segment based on the survey data; and then predict a target area where a preset traffic event involving the one or more traffic participants will occur on the target road segment based on the movement information of the one or more traffic participants. Determining the movement information of the one or more traffic participants may include: identifying the one or more traffic participants in the survey data to determine the one or more traffic participants; determining the location information of the one or more traffic participants at different times based on each frame of the survey data; and determining the movement information of the one or more traffic participants based on the location information of the one or more traffic participants at different times.

Exemplarily, a target prediction model of a preset traffic event may be obtained. The target prediction model may be a neural network model pre-trained based on sample data. The sample data may include the movement information of the one or more traffic participants and the annotated area where the traffic event occurs in the survey data. The movement information of the one or more traffic participants may be input into the target prediction model to obtain the prediction area of the preset traffic event in the survey data. Based on the prediction area, the target area where the preset traffic event will occur on the target road segment may be determined. The neural network model may include a convolutional neural network model, a recurrent convolutional neural network model, or a deep neural network model.

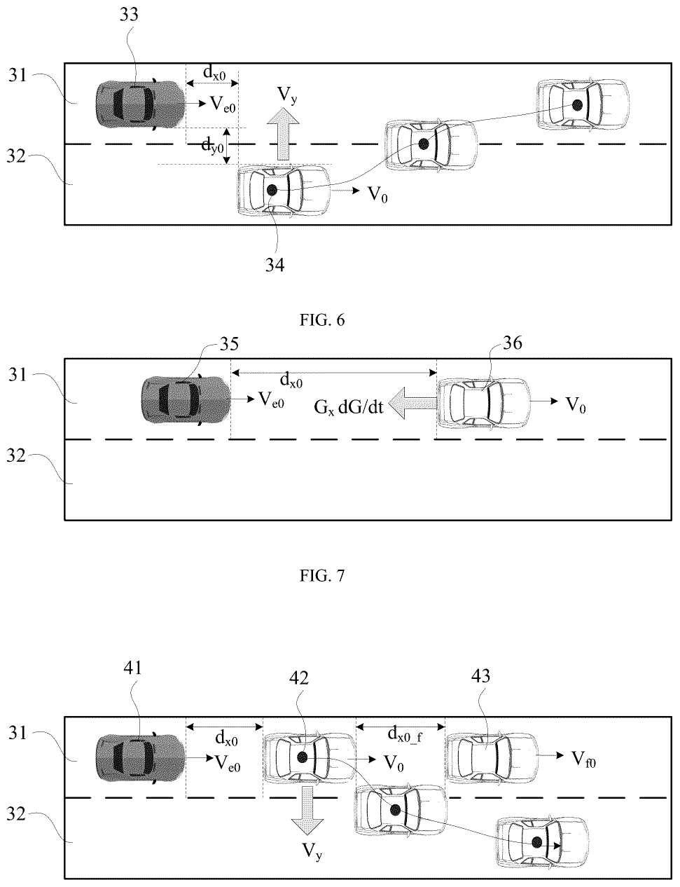

The preset traffic event may include a lane change and cut-in traffic event, a lane change and cut-out traffic event, or a front vehicle braking traffic event. The lane change and cut-in traffic event may refer to that a traffic participant in an adjacent lane cuts into the current lane, and may be defined by an initial speed of the first traffic participant, the initial relative speed between the first traffic participant and the second traffic participant, the initial longitudinal relative distance between the first traffic participant and the second traffic participant, the initial lateral relative distance between the first traffic participant and the second traffic participant, or the lateral speed of the second traffic participant. As shown in FIG. 6 which is a schematic diagram showing a scene of a lane change and cut-in traffic event, a traffic participant 33 is located in a lane 31, a traffic participant 34 is located in a lane 32. The traffic participant 34 enters the lane 31 from lane 32. The initial speed of the traffic participant 33 is Ve0, and the initial speed of the traffic participant 34 is V0. The initial relative speed is Ve0-V0. The initial longitudinal relative distance is dx0, and the initial lateral relative distance is dy0. The lateral speed of the traffic participant 34 is Vy.

For example, the front vehicle braking traffic event may refer to that the third traffic participant in the front in the lane brakes (decelerates or stops) affecting the fourth traffic participant behind the third traffic participant. The front vehicle braking traffic event may be determined by the initial speed of the fourth traffic participant, the initial relative speed between the third traffic participant and the fourth traffic participant, the initial longitudinal relative distance between the third traffic participant and the fourth traffic participant, or the deceleration and the changing rate of deceleration of the third traffic participant. As shown in FIG. 7, which is a schematic diagram showing a scene of a front vehicle braking traffic event, a traffic participant 35 and a traffic participant 36 are both located in a lane 31, and the traffic participant 36 drives before the traffic participant 35. When the traffic participant 36 brakes, the initial speed of the traffic participant 35 is Ve0, the initial speed of the traffic participant 36 is V0, and the initial relative speed is Ve0-V0. The initial longitudinal relative distance is dx0. After a period of t, the deceleration of the traffic participant 36 is Gx, and the changing rate of the deceleration is dG/dt.

In one embodiment, the lane change and cut-out traffic incident may refer to that the seventh traffic participant enters another land following the eighth traffic participant when the fifth traffic participant is following the seventh traffic participant in front of the sixth traffic participant in the front in the lane. The lane change traffic and cut-out event may be defined by two traffic sub-events. The first traffic sub-event may be defined by the initial speed of the sixth traffic participant, the relative speed between the sixth traffic participant and the seventh traffic participant, and the first longitudinal distance. The second traffic sub-event may be defined by the longitudinal relative distance, the initial speed of the fifth traffic participant, the initial relative speed between the fifth traffic participant and the sixth traffic participant, the second longitudinal relative distance, and the lateral speed when the sixth traffic participant starts to enter the other lane.

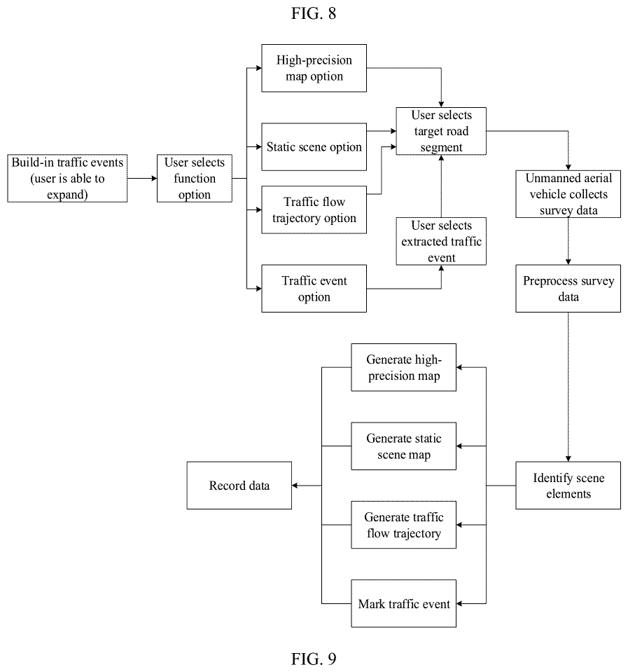

As shown in FIG. 8, which is a schematic diagram showing a scene of a lane-change and cut-out traffic event, a traffic participant 41, a traffic participant 42 and a traffic participant 43 are all located in a lane 31. The traffic participant 41 follows the traffic participant 42. When the traffic participant 42 begins to enter another lane 32, the initial speed of the traffic participant 42 is V0, the initial speed of the traffic participant 43 is Vf0, the initial relative speed between the traffic participant 42 and the traffic participant 43 is V0-Vf0, the first longitudinal relative distance is dx0_f, the initial speed of the traffic participant 41 is Ve0, the initial relative speed between the traffic participant 41 and the traffic participant 42 is Ve0-V0, the second longitudinal relative distance is dx0, and the lateral speed of the traffic participant 42 is Vy.

At S103, the survey data collected by the unmanned aerial vehicle is obtained, and the movement information of the one or more traffic participants on the target road segment is determined based on the survey data.

In one embodiment, scene elements in the survey data may be identified to determine the scene elements in each frame of the survey data, and the one or more traffic participants may be determined from the determined scene elements. The location information of the one or more traffic participants at different times may be determined based on each frame of the survey data. The movement information of the one or more traffic participants may be determined based on the location information of the one or more traffic participants at different times.

In one embodiment, the survey data may include image data or point cloud data. For the image data, the scene elements in the image data may be identified based on machine learning methods. For example, by extracting feature information of the scene elements in the image data and labeling classification labels, a large amount of sample data may be obtained. Machine learning may be performed on the large amount of sample data to obtain a scene element recognition model. When identifying the scene elements, the image data may be input to the scene element recognition model to identify the scene elements in the image data. For the point cloud data, the scene elements in the point cloud data may be identified based on feature extraction methods or raster map-based methods. For example, A method based on feature extraction may mainly establish the scene element recognition model through processes including clustering, geometric feature fitting, or feature vector extraction. Different recognition models need to be established for different scene elements.

The scene elements may include roads, lane lines, weather, time, road traffic participants, traffic infrastructure, roadside equipment, etc. The ground control platform may pre-define a scene description layer. For example, in one embodiment, the scene description layer may include six layers, namely the road layer L1, the transportation infrastructure layer L2, the temporary change layer L3 of L1 and L2, the dynamic object layer L4, the environment adjustment layer L5 and the digital information layer L6. The road layer L1 may include road geometry, lane lines, boundaries, etc. The transportation infrastructure layer L2 may include traffic signs, street lights, traffic lights, etc. The temporary change layer L3 of L1 and L2 may include information related to changes because of road projects, such as road maintenance warnings. The dynamic object layer L4 may include traffic participants. The environmental condition layer L5 may include weather, time, or other information (noise, buildings, flowers, trees, etc.), and the digital information layer L6 may include digital map information or V2X information.

In one embodiment, the survey data may be preprocessed. The preprocessing may include at least one of: removing noise data, scaling, cropping, or rotating. The movement information of the one or more traffic participants on the target road segment may be determined based on the preprocessed survey data. The survey data may include a plurality of frames of image data, and the deviation between the preprocessed plurality of frames of image data may satisfy a preset condition, such as being less than or equal to a preset deviation threshold. By preprocessing the survey data, the stability of the collected survey data may be ensured.

In one embodiment, the survey data may include a plurality of frames of image data. Therefore, preprocessing the survey data may include: determining reference image data from the plurality of frames of image data; extracting a plurality of first feature points in a first background area of the reference image data; extracting a plurality of second feature points in a second background area of the remaining image data of each frame in the plurality of frames of image data; according to the plurality of first feature points and the plurality of second feature points in the second background area of each frame of the remaining plurality of frames of image data, determining the position change relationship and size change relationship between the first background image and each second background area; according to the position change relationship and size change relationship, zooming, cropping, or rotating each frame of the remaining plurality of frames of image data. In one embodiment, the first frame of image data collected by the unmanned aerial vehicle may be determined as the reference image data. In other embodiments, the remaining plurality of frames of image data may also be determined as the reference image data.

In one embodiment, the survey data may include point cloud data. Therefore, preprocessing the survey data may include: determining noise points in the point cloud data, and eliminating noise points in the point cloud data. The difference between the height of the noise point and the height of points around the noise point may be larger than a preset height difference. By removing noise points from the point cloud data, the accuracy of the point cloud data may be improved.

At S104, according to the movement information of the traffic participants, target data fragments are marked in the survey data.

The movement information of the traffic participants in the target data fragments may meet preset movement information conditions. The preset movement information conditions may include one or more conditions. The target data fragments corresponding to different movement information conditions may be marked in the survey data. The movement information conditions may be set based on the actual situation or set by the user through the human-computer interaction page of the ground control platform, which is not specifically limited in the embodiments of the present disclosure.

In one embodiment, a traffic event involving the one or more traffic participants may be determined in the survey data based on the movement information of the traffic participants. And, the target data fragments corresponding to the traffic event may be marked in the survey data. The duration of the target data fragments may be larger than or equal to the duration of the traffic event, and the determined traffic event may be related to the movement information conditions. Since the duration of the marked target data fragments may be larger than or equal to the duration of the traffic event, the marked target data fragments may completely include the traffic event involving the one or more traffic participants, ensuring the integrity of the traffic event.

In one embodiment, marking the target data fragments corresponding to the traffic event in the survey data may include: determining the start time and end time of the traffic event in the survey data; and marking the target data fragments corresponding to the traffic event in the survey data based on the start time and end time of the traffic event in the survey data. For example, a data fragment between the start time and the end time may be marked in the survey data, and the duration of the data fragment between the start time and the end time may be equal to the duration of the traffic event.

For another example, subtraction may be performed between the start time and a first duration to obtain the target start time. Addition may be performed between the end time and a second duration to obtain the target end time. A data fragment between the target start time and the target end time may be marked. The duration of the data fragment between the target start time and the target end time may be longer than the duration of the traffic event. The first duration and the second duration may be the same or different. The first duration and the second duration may be set by the user. These are not specifically limited in the embodiments of the present disclosure.

The user may select one or more traffic events to be marked through the human-computer interaction page of the ground control platform, such that the ground control platform may determine the movement information conditions corresponding to the one or more traffic events based on the one or more traffic events selected by the user. And the movement information conditions may be stored. Therefore, when the ground control platform obtains the survey data collected by the unmanned aerial vehicle, the ground control platform may be able to mark the target data fragments in the survey data based on the stored movement information conditions.

Different traffic events may correspond to different movement information conditions. For example, the movement information condition corresponding to the lane change and cut-in traffic event may include that: the lateral speed of the cutting vehicle remains unchanged in the same direction, the cutting vehicle rushes out of its lane from the adjacent lane, or there is no gap between the cutting vehicle and the vehicle to be cut. The starting condition of the lane change and cut-in traffic event may include that: the lateral speed of the cutting vehicle increases from zero. The end condition of the lane change and cut-in traffic event may include that the lateral speed of the cutting vehicle decreases to zero.

In one embodiment, the movement information conditions corresponding to the front vehicle braking traffic event may include: the deceleration of the traffic participant is larger than the set value, and there are other traffic participants in the set area behind the decelerating traffic participant. The start condition of the front vehicle braking traffic event may include that the deceleration and the changing rate of the deceleration increase from zero. The end condition of the front vehicle braking traffic event may include that the deceleration and the changing rate of the deceleration decrease to zero.

In one embodiment, the movement information condition corresponding to the lane change and cut-out traffic event may include that: the lateral speed of the cutting vehicle remains unchanged in the same direction, the cutting vehicle rushes out of its own lane from the adjacent lane, there are other vehicles in a set area in front of the cutting vehicle, and there are other vehicles in a set area behind the cutting vehicle. The start condition of the lane change and cut-out traffic event may include that the lateral speed of the cutting-in vehicle increases from zero. The end condition of the lane change and cut-out traffic event may include that the lateral speed of the cutting-in vehicle decreases to zero.

In one embodiment, for a frame of survey data, all lanes and all vehicles in the survey data may be identified. A Car ID may be assigned to each vehicle, and a Lane ID may be assigned to each lane. A target vehicle may be selected in sequence according to the size of the Car ID. For the target vehicle, based on the continuous plurality of frames of the survey data, whether the Lane ID of the target vehicle changes may be determined. When the Lane ID of the target vehicle changes, the target vehicle may have changed lanes, and whether the target vehicle's lane after cutting is adjacent to the lane before cutting and whether there are other vehicles in the set area behind the lane after cutting may be determined. When the target vehicle's lane after cutting is adjacent to the lane before cutting and there are other vehicles in the set area behind the lane after the cutting in, the cut-in start time and cut-in end time of the target vehicle may be determined. Based on the cut-in start time and cut-in end time, the target data fragment corresponding to the lane change and cut-in traffic event may be marked in the survey data.

In one embodiment, based on the plurality of frames of the survey data including the target vehicle, a distance between the target vehicle and the lane centerline and/or the lateral speed of the target vehicle may be determined. Based on the distance between the target vehicle and the lane centerline and/or the lateral speed of the target vehicle, the cut-in start time and cut-in end time of the target vehicle may be determined. For example, the moment when the target vehicle's lateral speed increases from zero may be determined as the cut-in start time, and the moment when the target vehicle's lateral speed decreases to zero may be determined as the cut-in end time. In another embodiment, the moment when the distance between the lane centerline and the target vehicle before cutting in increases to a preset first distance may be determined as the cut-in start time, and the moment when the distance between the target vehicle and the lane centerline after cut-in decreases to the preset second distance may be determined as the cut-in end time.

In one embodiment, for the target vehicle, based on the continuous plurality of frames of the survey data, whether the Lane ID of the target vehicle changes may be determined. When the Lane ID of the target vehicle changes, the target vehicle may have changed lanes. Then whether the lane of the target vehicle after the cut-in and the lane of the target vehicle after the cut-in are adjacent, and whether there are vehicles in the set area in front of and behind the target vehicle in the lane before cutting may be determined. When the lane of the target vehicle after cut-in is adjacent to the lane before cut-in, and there are vehicles in the set area in front of and behind the target vehicle in the lane before cut-in, the cut-in start time and cut-in end time of the target vehicle may be determined. And based on the cut-in start time and cut-in end time, the target data fragment corresponding to the lane change and cut-out traffic event may be marked in the survey data.

In one embodiment, for the target vehicle, based on the continuous plurality of frames of the survey data, whether the deceleration of the target vehicle is larger than a preset deceleration may be determined. When the deceleration of the target vehicle is larger than the preset deceleration, whether there are other vehicles in the set area behind the target vehicle may be determined. When there are other vehicles in the set area behind the target vehicle, the deceleration start time and deceleration end time of the target vehicle may be determined. And based on the deceleration start time and deceleration end time of the target vehicle, the target data fragment corresponding to the front vehicle braking traffic event may be marked in the survey data. The preset deceleration may be set according to actual needs, which is not limited in the present disclosure.

In one embodiment, for the target vehicle, based on the continuous plurality of frames of the survey data, whether the changing rate of the deceleration of the target vehicle is larger than a preset changing rate of the deceleration may be determined. When the changing rate of the deceleration of the target vehicle is larger than the preset changing rate of the deceleration, whether there are other vehicles in the set area behind the target vehicle may be determined. When there are other vehicles in the set area behind the target vehicle, the deceleration start time and deceleration end time of the target vehicle may be determined. And based on the deceleration start time and deceleration end time of the target vehicle, the target data fragment corresponding to the front vehicle braking traffic event may be marked in the survey data. The preset changing rate of the deceleration may be set according to actual needs, which is not limited in the present disclosure.

In one embodiment, for the target vehicle, based on the continuous plurality of frames of the survey data, whether the deceleration of the target vehicle is larger than a preset deceleration may be determined, and whether the changing rate of the deceleration of the target vehicle is larger than a preset changing rate of the deceleration may be determined. When the deceleration of the target vehicle is larger than the preset deceleration and the changing rate of the deceleration of the target vehicle is larger than the preset changing rate of the deceleration, whether there are other vehicles in the set area behind the target vehicle may be determined. When there are other vehicles in the set area behind the target vehicle, the deceleration start time and deceleration end time of the target vehicle may be determined. And based on the deceleration start time and deceleration end time of the target vehicle, the target data fragment corresponding to the front vehicle braking traffic event may be marked in the survey data.

In one embodiment, the marked survey data may be stored. Alternatively, the target data fragments may be intercepted from the survey data, and the intercepted target data fragments may be stored. By intercepting and storing target data fragments from the survey data, data corresponding to the traffic event involving the one or more traffic participants may be collected to facilitate subsequent safety verification of autonomous vehicles.

After the ground control platform completes the marking of the survey data, the ground control platform may store four files, namely the first file, the second file, the third file and the fourth file. The first file may include the original survey data (unprocessed survey data) of the target road segment. The second file may include lanes, traffic signs, the speed limit of each lane, etc. The third file may include vehicle information for each lane. The vehicle information of a lane may include vehicle size, vehicle class, vehicle driving direction or average vehicle speed on the lane. The fourth file may include speed, acceleration, lane position or surrounding vehicle information of the vehicle in each lane in each frame of survey data. The second file, the third file and the fourth file may be comma-separated values (CSV) files.

In one embodiment, dynamic targets in the survey data may be identified to obtain one or more dynamic targets on the target road segment. Based on the survey data, the location information and speed information of each dynamic target on the target road segment may be determined. According to the location information and speed information of each dynamic target on the target road segment, traffic flow trajectory of the target road segment may be generated. The location information and speed information of each dynamic target at different times on the target road segment may be determined based on the continuous plurality of frames of the survey data. Through the location information and speed information of each dynamic target at different times, the movement trajectory of each dynamic target may be obtained through fitting, such that the traffic flow trajectory of the target road segment can be generated.

In one embodiment, static targets in the survey data may be identified to obtain one or more static targets on the target road segment. A static scene map of the target road segment may be generated based on the survey data of the one or more static targets. The static scene map may be stored in a format of Open DRIVE. Static targets may include roads, traffic signs, street lights, traffic lights, etc. The static scene map may include road networks, traffic signs, street lights, traffic lights, etc. The survey data may include laser point cloud data or image data. Through the laser point cloud data or the image data of the static targets, the static scene map of the target road segment may be generated.

In one embodiment, a high-precision map of the target road segment may be generated based on the survey data. The survey data may include a plurality of frames of laser point cloud data. Through the plurality of frames of laser point cloud data, the high-precision map of the target road segment may be quickly created. For example, the plurality of frames of laser point cloud data may be spliced to obtain a point cloud map of the target road segment. Lane lines, traffic signs, traffic lights, street lights, surrounding buildings, flowers, trees, etc. may be marked on the point cloud map to obtain the high-precision map of the target road segment.

In one embodiment, the ground control platform may be able to simultaneously complete at least one of: marking the target data fragment in the survey data, generating the traffic flow trajectory of the target road segment; generating the static scene map of the target road segment; or creating the high-precision maps of the target road segment. The operations completed by the ground control platform may be set by the user based on the function options in the human-computer interaction page, which is not specifically limited in the embodiment of the present disclosure.

In one embodiment shown in FIG. 9, by building in multiple traffic events in advance, the user may also expand according to the actual situation. The user may select the required function options through the function option selection page, and may choose one or more of the high-precision map options, the static scene options, the traffic flow trajectory option, or the traffic event option. After selecting the traffic event option, the user may select the extracted traffic event. After selecting the function option, the user may select the target road segment. Then, the unmanned aerial vehicle may collect the survey data of the target road segment, and the survey data collected by the unmanned aerial vehicle may be pre-processed. Subsequently, based on the function option selected by the user and based on the pre-processed survey data, a high-precision map may be constructed, a static scene map may be constructed, a traffic flow trajectory may be generated, and/or the target data fragment corresponding to the traffic event may be marked in the survey data. Then, the data may be recorded.

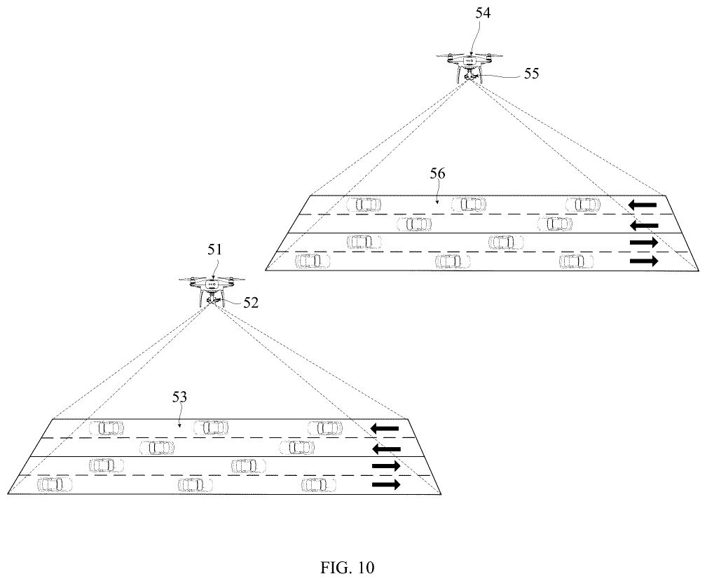

In one embodiment, the ground control platform may control a plurality of unmanned aerial vehicles to collect the survey data on different target road segments, and obtain the survey data collected by the plurality of unmanned aerial vehicles on different target road segments. Target data fragments corresponding to a same traffic event may be marked in the survey data of different target road segments, or target data fragments corresponding to different traffic events may be marked in the survey data of different target road segments. As shown in FIG. 10, an unmanned aerial vehicle 51 is located above a target road segment 53 to collect the first survey data of the target road segment 53 through the sensor 52, and an unmanned aerial vehicle 54 is located above a target road segment 56 to collect the second survey data of the target road segment 56 through the sensor 55. The location information of the target road segment 53 is different from the location information of the target road segment 56.

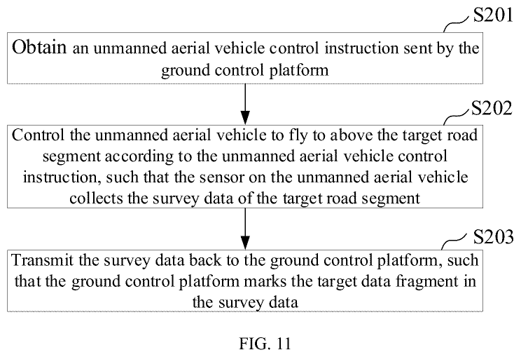

The present disclosure also provides a data collecting method. As shown in FIG. 11, in one embodiment, the data collecting method includes S201 to S203.

At S201, an unmanned aerial vehicle control instruction sent by the ground control platform is obtained.

The unmanned aerial vehicle control instruction may be generated by the ground control platform based on the location information of the target road segment. The location information of the target road segment may be determined based on the user's operation on the human-computer interaction page of the ground control platform.

For example, the ground control platform may display a road segment selection page, where the road segment selection page includes a map. The road segment starting point and the road segment end point selected by the user in the map may be obtained. The target road segment whose data is to be collected data and the location information of the road segment may be determined based on the road segment starting point and the road segment end point.

At S202, the unmanned aerial vehicle is controlled to fly to above the target road segment according to the unmanned aerial vehicle control instruction, such that the sensor on the unmanned aerial vehicle collects the survey data of the target road segment.

In one embodiment, when the unmanned aerial vehicle arrives above the target road segment, the hovering height in the unmanned aerial vehicle control instruction may be obtained. The unmanned aerial vehicle may be controlled to hover over the target road segment at the hovering height. The hovering height may be set based on the height of the traffic participants on the target road segment and the safety height. By hovering the unmanned aerial vehicle over the target road segment, fixed-point collection of the survey data on the target road segment may be achieved. The power consumption of the unmanned aerial vehicle may also be reduced and the endurance of the unmanned aerial vehicle may be improved.

In one embodiment, when the unmanned aerial vehicle arrives above the target road segment, the flying speed in the unmanned aerial vehicle control instruction may be obtained. The unmanned aerial vehicle may be controlled to fly over the target road segment at the flying speed. The flying speed in the unmanned aerial vehicle control instruction may be set by the user. By controlling the unmanned aerial vehicle to fly over the target road segment according to the preset flight speed, the unmanned aerial vehicle may collect the survey data covering the entire target road segment, thereby collecting more complete survey data.

In one embodiment, a data collection duration in the unmanned aerial vehicle control instruction may be obtained, and the unmanned aerial vehicle may be controlled to fly over the target road segment within the duration, such that the sensor on the unmanned aerial vehicle collects the survey data of the target road segment within the duration. The duration may be set according to the actual condition or by the user, which is not specifically limited in the present disclosure. By controlling the unmanned aerial vehicle to fly over the target road segment within the set duration to collect the survey data of the target road segment within the set time period, the collection of the survey data in the specific duration may be achieved.

In one embodiment, the movement direction of the traffic participants on the target road segment may be determined according to the survey data, and the unmanned aerial vehicle may be controlled to fly over the target road segment in the same or opposite direction as the movement direction of the traffic participants on the target road segment. For example, the method of determining the movement direction of the traffic participants on the target road segment based on the survey data may include: determining the traffic participants in each frame of the survey data, determining the location information of the traffic participants at different times based on each frame of the survey data, and determining the movement direction of the traffic participants on the target road segment based on the location information of the traffic participants at different times. The survey data of the target road segment collected by the unmanned aerial vehicle flying over the target road segment may record the forward or backward correlation of the traffic participants in the long-range road segment. When the unmanned aerial vehicle flies over the target road segment in the opposite direction to the movement direction of the traffic participants on the target road segment, the survey data may be collected faster.

In one embodiment, the control system of the unmanned aerial vehicle may predict a target area where a preset traffic event will occur on the target road segment based on the survey data; and then control the unmanned aerial vehicle to be located over the target area based on the location information of the target area. The preset traffic event may be defined by the movement information of one or more traffic participants. The preset traffic event may be defined and set by the user. This is not specifically limited in the embodiments of the present disclosure. By predicting the target area where the preset traffic event will occur on the target road segment and controlling the unmanned aerial vehicle to be located over the target area, the survey data containing preset traffic data may be collected faster.

In one embodiment, the movement information of one or more traffic participants on the target road segment may be determined based on the survey data; and then a target area where a preset traffic event involving the one or more traffic participants will occur may be predicted on the target road segment based on the movement information of the one or more traffic participants. Determining the movement information of the one or more traffic participants may include: identifying the one or more traffic participants in the survey data to determine the one or more traffic participants; determining the location information of the one or more traffic participants at different times based on each frame of the survey data; and determining the movement information of the one or more traffic participants based on the location information of the one or more traffic participants at different times.

In one embodiment, a target prediction model of a preset traffic event may be obtained. The target prediction model may be a neural network model pre-trained based on sample data. The sample data may include the movement information of the one or more traffic participants and the annotated area where the traffic event occurs in the survey data. The movement information of the one or more traffic participants may be input into the target prediction model to obtain the prediction area of the preset traffic event in the survey data. Based on the prediction area, the target area where the preset traffic event will occur on the target road segment may be determined. The neural network model may include a convolutional neural network model, a recurrent convolutional neural network model, or a deep neural network model.

At S203, the survey data is sent back to the ground control platform, such that the ground control platform marks the target data fragment in the survey data.

The movement information of the traffic participants located on the target road segment in the target data fragment may meet the preset movement information conditions. For the specific implementation process of the ground control platform marking the target data fragment in the survey data, the reference may be made to the embodiments of the aforementioned data processing methods, and will not be described again here.

In one embodiment, during the process of collecting survey data of the target road segment by the unmanned aerial vehicle, the collected survey data may be transmitted back to the ground control platform regularly or in real time. In another embodiment, the remaining battery power of the unmanned aerial vehicle may be obtained. When the remaining battery power of the unmanned aerial vehicle is less than the preset power, the collected survey data may be transmitted back to the ground control platform. The timing duration and preset power level may be set by the user, and this is not specifically limited in the embodiments of the present disclosure.

In one embodiment, the unmanned aerial vehicle may be connected to a ground power source through a tethering cable, and the ground power source may be used to provide power for the battery of the unmanned aerial vehicle. Alternatively, the remaining battery power of the unmanned aerial vehicle may be obtained. When the remaining battery power of the unmanned aerial vehicle is less than the preset power threshold, a replacement instruction may be sent to a backup unmanned aerial vehicle based on the current location of the unmanned aerial vehicle, such that the backup unmanned aerial vehicle flies to the waiting point based on the replacement instruction. After the backup unmanned aerial vehicle arrives at the waiting point, the unmanned aerial vehicle may return from the current location point and the backup unmanned aerial vehicle may fly from the waiting point to the current location point, allowing the backup unmanned aerial vehicle to continue collecting the survey data of the target road segment.

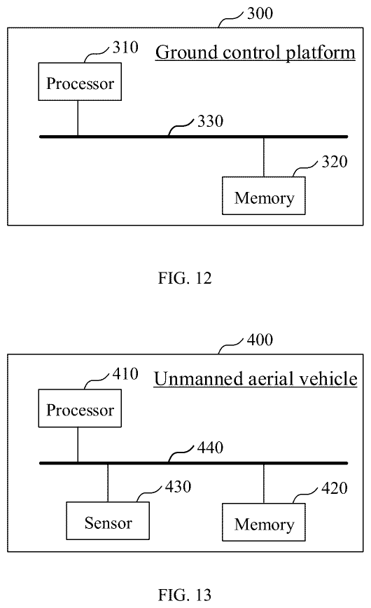

The present disclosure also provides a ground control platform. As shown in FIG. 12, which is a structural schematic diagram of the ground control platform, in one embodiment, the ground control platform 300 may include a processor 310 and a memory 320. The processor 310 and the memory 320 may be connected through a bus 330. The bus 330 may be, for example, an I2C (Inter-integrated Circuit) bus.

The processor 310 may be a micro-controller unit (MCU), a central processing unit (CPU), or a digital signal processor (DSP), etc.

The memory 320 may be a flash chip, a read-only memory (ROM) disk, an optical disk, a flash disk, or a mobile hard disk, etc.

The processor 310 may be configured to execute a computer program stored in the memory 320 to:
obtain location information of a target road segment;
generate an unmanned aerial vehicle control instruction based on the location information of the target road segment, where the unmanned aerial vehicle control instruction is used to instruct the unmanned aerial vehicle to fly to above the target road segment such that a sensor on the unmanned aerial vehicle collects survey data of the target road segment;
obtain the survey data collected by the unmanned aerial vehicle and determine movement information of one or more traffic participants on the target road segment according to the survey data; and
mark target data fragments in the survey data according to the movement information of the one or more traffic participants on the target road segment. The movement information of the traffic participants located on the target road segment in the target data fragments may meet the preset movement information conditions.

In one embodiment, when the processor is configured to mark the target data fragments in the survey data according to the movement information of the one or more traffic participants on the target road segment, the processor may be configured to:
according to the movement information of the one or more traffic participants, determine a traffic event involving the one or more traffic participants in the survey data; and
mark the target data fragments corresponding to the traffic event in the survey data.

The duration of the target data fragments may be larger than or equal to the occurrence duration of the traffic event.

In one embodiment, the determined traffic event may be related to the movement information condition.

In one embodiment, the one or more traffic participants may include: motor vehicles, non-motor vehicles, pedestrians, or animals.

In one embodiment, the unmanned aerial vehicle control instruction may be also used to instruct the unmanned aerial vehicle to hover over the target road segment and/or fly over the target road segment at a preset flight speed.

In one embodiment, the unmanned aerial vehicle control instruction may be used to instruct the unmanned aerial vehicle to fly over the target road segment in a preset time period, such that the sensor mounted at the unmanned aerial vehicle collects the survey data of the target road segment within the time period.

In one embodiment, the unmanned aerial vehicle control instruction maybe also used to instruct the unmanned aerial vehicle to fly over the target road segment in the same or opposite direction as the movement direction of the one or more traffic participants on the target road segment.

In one embodiment, the unmanned aerial vehicle control instruction may be used to instruct a plurality of unmanned aerial vehicles to fly over the target road segment, such that sensors mounted at the plurality of unmanned aerial vehicles collect the survey data of the target road segment. The survey data collected by the plurality of unmanned aerial vehicles may be spliced based on the time dimension and/or the location dimension.

In one embodiment, the unmanned aerial vehicle control instruction may be used to instruct a plurality of unmanned aerial vehicles to fly to different locations over the target road segment and hover, such that sensors mounted at the plurality of unmanned aerial vehicles collect the survey data of the target road segment at different locations.

In one embodiment, the unmanned aerial vehicle control instruction may be used to instruct a plurality of unmanned aerial vehicles to fly over the target road segment in different time periods, such that sensors on the plurality of unmanned aerial vehicles collect the survey data of the target road segment in different time periods.

In one embodiment, the unmanned aerial vehicle control instruction may be used to instruct a first unmanned aerial vehicle to fly over the target road segment and fly in the same direction as the movement direction of the traffic participants on the target road segment, and may be also used to instruct a second unmanned aerial vehicle to fly over the target road segment and fly in a direction opposite to the movement direction of the traffic participants on the target road segment.

In one embodiment, the unmanned aerial vehicle control instruction may be also used to instruct the unmanned aerial vehicle to adjust the sensing direction of the sensor such that the sensing direction of the sensor faces the target road segment.

In one embodiment, the sensor may be coupled and mounted at a gimbal of the unmanned aerial vehicle, and the gimbal may be used to adjust the sensing direction of the sensor.

In one embodiment, when determining the movement information of the one or more traffic participants on the target road segment based on the survey data, the processor may be configured to:
preprocess the survey data, where the preprocessing includes at least one of: removing noise data, scaling, cropping, or rotating; and
determine the movement information of the one or more traffic participants on the target road segment based on the preprocessed survey data.

In one embodiment, the survey data may include a plurality of frames of image data, and the deviation between the plurality of frames of image data after preprocessing may satisfy a preset condition, such as being less than or equal to a preset deviation threshold.

In one embodiment, the processor may be further configured to:
identify dynamic targets in the survey data to obtain one or more dynamic targets on the target road segment;
determine location information and speed information of each dynamic target on the target road segment; and
based on the location information and speed information of each dynamic target on the target road segment, generate the traffic flow trajectory of the target road segment.

In one embodiment, the processor may be also configured to:
identify static targets in the survey data to obtain one or more static targets on the target road segment; and
based on the survey data of the one or more static targets, generate a static scene map of the target road segment.

In one embodiment, the processor may be further configured to:
create a high-precision map of the target road segment based on the survey data.

In one embodiment, the processor may be further configured to intercept the target data fragments from the survey data and store the intercepted target data fragments.

The present disclosure also provides an unmanned aerial vehicle. As shown in FIG. 13, which is a schematic structural diagram of an unmanned aerial vehicle 400, the unmanned aerial vehicle 400 includes a processor 410, a memory 420, and a sensor 430. The processor 410, the memory 420, and the sensor 430 are connected to each other through a bus 440. The bus 440 may be, for example, an inter-integrated circuit (I2C) bus.

The processor 410 may be a micro-controller unit (MCU), a central processing unit (CPU), or a digital signal processor (DSP), etc.

The memory 420 may be a flash chip, a read-only memory (ROM) disk, an optical disk, a flash disk, or a mobile hard disk, etc.

The processor 410 may be configured to execute a computer program stored in the memory 420 to:
obtain an unmanned aerial vehicle control instruction sent by the ground control platform;
control the unmanned aerial vehicle to fly to above the target road segment according to the unmanned aerial vehicle control instruction, such that the sensor on the unmanned aerial vehicle collects the survey data of the target road segment; and
transmit the survey data back to the ground control platform, such that the ground control platform marks the target data fragments in the survey data.

In one embodiment, the processor may be further configured to:
when the unmanned aerial vehicle arrives above the target road segment, obtain a hovering height in the unmanned aerial vehicle control instruction; and
control the unmanned aerial vehicle to hover over the target road segment at the hovering height.

In one embodiment, the processor may be further configured to:
when the unmanned aerial vehicle arrives above the target road segment, obtain a flying speed in the unmanned aerial vehicle control instruction; and
control the unmanned aerial vehicle to fly over the target road segment at the flying speed.

In one embodiment, when controlling the unmanned aerial vehicle to fly to above the target road segment according to the unmanned aerial vehicle control instruction, the processor may be configured to:
obtain a data collection duration in the unmanned aerial vehicle control instruction; and
control the unmanned aerial vehicle to fly to the target road segment within the duration, such that the sensor on the unmanned aerial vehicle collects the survey data of the target road segment within the duration.

In one embodiment, the processor may be further configured to:
determine the movement direction of the traffic participants on the target road segment according to the survey data; and
control the unmanned aerial vehicle to fly over the target road segment in the same or opposite direction as the movement direction of the traffic participants on the target road segment.

In one embodiment, the unmanned aerial vehicle control instruction may be used to instruct a plurality of unmanned aerial vehicles to fly over the target road segment, such that sensors carried by the plurality of unmanned aerial vehicles collect the survey data of the target road segment. The survey data collected by the plurality of unmanned aerial vehicles may be spliced based on the time dimension and/or position dimension.

In one embodiment, the unmanned aerial vehicle control instruction may be used to instruct the plurality of unmanned aerial vehicles to fly to different locations over the target road segment and hover, such that the sensors carried by the plurality of unmanned aerial vehicles collect the survey data of the target road segment at different locations.

In one embodiment, the unmanned aerial vehicle control instruction may be used to instruct the plurality of unmanned aerial vehicles to fly over the target road segment at different time periods, such that the sensors carried by the plurality of unmanned aerial vehicles collect the survey data of the target road segment at different time periods.

In one embodiment, the unmanned aerial vehicle control instruction may be used to instruct a first unmanned aerial vehicle to fly over the target road segment and fly in the same direction as the movement direction of the traffic participants on the target road segment, and may be also used to instruct the second unmanned aerial vehicle to fly over the target road segment and fly in the opposite direction to the movement direction of the traffic participants on the target road segment.

In one embodiment, the processor may be further configured to:
when the unmanned aerial vehicle arrives above the target road segment, adjust the sensing direction of the sensor such that the sensing direction of the sensor faces the target road segment.

In one embodiment, the sensor may be coupled and mounted at a gimbal of the unmanned aerial vehicle, and the gimbal may be used to adjust the sensing direction of the sensor.

In one embodiment, the processor may be further configured to:
predict a target area where a preset traffic event will occur on the target road segment based on the survey data; and then control the unmanned aerial vehicle to be located over the target area based on the location information of the target area.

In one embodiment, when predicting the target area where the preset traffic event will occur on the target road segment based on the survey data, the processor may be configured to:
determine the movement information of one or more traffic participants on the target road segment based on the survey data; and then predict the target area where the preset traffic event involving the one or more traffic participants will occur on the target road segment based on the movement information of the one or more traffic participants.

In one embodiment, when predicting the target area where the preset traffic event involving the one or more traffic participants will occur on the target road segment based on the movement information of the one or more traffic participants, the processor may be configured to:
obtain a target prediction model of the preset traffic event, where the target prediction model may be a neural network model pre-trained based on sample data and the sample data may include the movement information of the one or more traffic participants and the annotated area where the traffic event occurs in the survey data;
input the movement information of the one or more traffic participants into the target prediction model to obtain a prediction area of the preset traffic event in the survey data; and
based on the prediction area, determine the target area where the preset traffic event will occur on the target road segment.

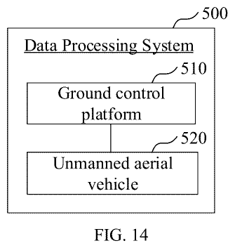

The present disclosure also provides a data processing system. As shown in FIG. 14, which is a schematic structural diagram of a data processing system 500 in one embodiment, the data processing system 500 includes a ground control platform 510 and an unmanned aerial vehicle 520. The ground control platform 510 and the unmanned aerial vehicle 520 are connected in communication.

The ground control platform 510 may be used to obtain the location information of the target road segment.

The ground control platform 510 may be also used to generate an unmanned aerial vehicle control instruction according to the location information of the target road segment, and send the unmanned aerial vehicle control instruction to the unmanned aerial vehicle 520.

The unmanned aerial vehicle 520 may be used to receive the unmanned aerial vehicle control instruction sent by the ground control platform, and fly over the target road segment according to the unmanned aerial vehicle control instruction.

The unmanned aerial vehicle 520 may be also used to collect the survey data of the target road segment through the sensor of the unmanned aerial vehicle when arriving above the target road segment, and send the survey data to the ground control platform.

The ground control platform 510 may be also used to obtain the survey data collected by the unmanned aerial vehicle 520, and determine the movement information of one or more traffic participants on the target road segment based on the survey data; the ground.

The control platform 510 may be further configured to mark a target data fragment in the survey data according to the movement information of the traffic participants, where the movement information of the traffic participants in the target data fragment meets a preset movement information condition.

In one embodiment, the ground control platform 510 may be further configured to:
determine a traffic event involving one or more traffic participants in the survey data according to the movement information of the traffic participants; and
mark the target data fragment corresponding to the traffic event in the survey data, where the duration of the target data fragment may be larger than or equal to the occurrence duration of the traffic event.

In one embodiment, the determined traffic event may be related to the movement information condition.

In one embodiment, the traffic participants may include: motor vehicles, non-motor vehicles, pedestrians, or animals.

In one embodiment, the ground control platform 510 may be also used to:
display a road segment selection page, where the road segment selection page includes a map;
obtain a road segment starting point and a road segment end point selected by the user in the map; and
according to the road segment starting point and the road segment end point, determine the target road segment whose data is to be collected and the location information of the target road segment.

In one embodiment, the ground control platform 510 may be also used to:
preprocess the survey data, where the preprocessing includes at least one of: removing noise data, scaling, cropping, or rotating; and
determine the movement information of the one or more traffic participants on the target road segment based on the preprocessed survey data.

In one embodiment, the survey data may include a plurality of frames of image data, and the deviation between the plurality of frames of image data after preprocessing may satisfy a preset condition, such as being less than or equal to a preset deviation threshold.

In one embodiment, the ground control platform 510 may be also used to:
identify dynamic targets in the survey data to obtain one or more dynamic targets on the target road segment;
determine location information and speed information of each dynamic target on the target road segment; and
based on the location information and speed information of each dynamic target on the target road segment, generate the traffic flow trajectory of the target road segment.

In one embodiment, the ground control platform 510 may be also used to:
identify static targets in the survey data to obtain one or more static targets on the target road segment; and
based on the survey data of the one or more static targets, generate a static scene map of the target road segment.

In one embodiment, the ground control platform 510 may be also used to:
create a high-precision map of the target road segment based on the survey data.

In one embodiment, the ground control platform 510 may be also used to:
intercept the target data fragments from the survey data and store the intercepted target data fragments.

In one embodiment, the unmanned aerial vehicle may be further configured to:
when the unmanned aerial vehicle arrives above the target road segment, obtain a hovering height in the unmanned aerial vehicle control instruction; and
hover over the target road segment at the hovering height.

In one embodiment, the unmanned aerial vehicle may be further configured to:
when the unmanned aerial vehicle arrives above the target road segment, obtain a flying speed in the unmanned aerial vehicle control instruction; and
fly over the target road segment at the flying speed.

In one embodiment, the unmanned aerial vehicle may be further configured to:
obtain a data collection duration in the unmanned aerial vehicle control instruction; and
fly to the target road segment within the duration, such that the sensor on the unmanned aerial vehicle collects the survey data of the target road segment within the duration.

In one embodiment, the unmanned aerial vehicle may be further configured to:
determine the movement direction of the traffic participants on the target road segment according to the survey data; and
control the unmanned aerial vehicle to fly over the target road segment in the same or opposite direction as the movement direction of the traffic participants on the target road segment.

In one embodiment, the unmanned aerial vehicle may be further configured to:
when the unmanned aerial vehicle arrives above the target road segment, adjust the sensing direction of the sensor such that the sensing direction of the sensor faces the target road segment.

In one embodiment, the sensor may be coupled and mounted at a gimbal of the unmanned aerial vehicle, and the gimbal may be used to adjust the sensing direction of the sensor.

In one embodiment, the unmanned aerial vehicle may be further configured to:
predict a target area where a preset traffic event will occur on the target road segment based on the survey data; and then control the unmanned aerial vehicle to be located over the target area based on the location information of the target area.

In one embodiment, the unmanned aerial vehicle may be further configured to:
determine the movement information of one or more traffic participants on the target road segment based on the survey data; and then predict the target area where the preset traffic event involving the one or more traffic participants will occur on the target road segment based on the movement information of the one or more traffic participants.

In one embodiment, the unmanned aerial vehicle may be further configured to:
obtain a target prediction model of the preset traffic event, where the target prediction model may be a neural network model pre-trained based on sample data and the sample data may include the movement information of the one or more traffic participants and the annotated area where the traffic event occurs in the survey data;
input the movement information of the one or more traffic participants into the target prediction model to obtain a prediction area of the preset traffic event in the survey data; and
based on the prediction area, determine the target area where the preset traffic event will occur on the target road segment.

The present disclosure also provides a computer-readable storage medium. The computer-readable storage medium may be configured to store a computer program. When the computer program is executed by a processor, the data processing method or the data collecting method provided by various embodiments of the present disclosure may be implemented.

The computer-readable storage medium may be an internal storage unit of a control platform described in any of the foregoing embodiments of the present disclosure, such as a hard disk or a memory of the device. The computer-readable storage medium may also be an external storage device of the device, such as a plug-in hard disk equipped on the device, a smart memory card (SMC), a secure digital card (SD), or a flash card, etc. The computer-readable storage medium may also include both an internal storage unit of the platform device and an external storage device. The computer-readable storage medium may be used to store a computer program or other programs and data required by a platform device. The computer-readable storage medium can also be used to temporarily store data that has been output or will be output.

All or part of the process in the method of the above embodiments may be implemented through a computer program instructing related hardware. The program may be stored in a readable storage medium. When the program is executed, it may implement the above-mentioned method provided by various embodiments of the present disclosure. The storage medium may be a magnetic disk, an optical disk, a read-only memory (ROM) or a random access memory (RAM), and the like.

The terminology used in the present disclosure is for the purpose of describing particular embodiments only and is not intended to limit the scope of the present disclosure.

The term “and/or” used in the present disclosure and the appended claims refers to any combination of one or more of the associated listed items and all possible combinations, and includes these combinations.

The above are only specific implementations of embodiments of the present disclosure, but the scope of the present disclosure is not limited to this. One of ordinary skills in the art can easily think of various equivalents within the technical scope disclosed in the present disclosure. These modifications or replacements shall be included within the scope of the present disclosure. Therefore, the protection scope of the present invention shall be subject to the protection scope of the claims.

What is claimed is:

1. A data processing method comprising:
obtaining location information of a target path;
generating a control instruction according to the location information, to instruct a mobile platform to move to above the target path;
obtaining survey data of the target path collected by a sensor of the mobile platform and determining status information of one or more traffic participants on the target path based on the survey data; and
marking a target data fragment in the survey data according to the status information of the one or more traffic participants, status information of the one or more traffic participants in the target data fragment satisfying a preset status information condition.

2. The method according to claim 1, wherein marking the target data fragment includes:
determining, from the survey data, a traffic event involving the one or more traffic participants according to the status information of the one or more traffic participants; and
marking a data fragment corresponding to the traffic event in the survey data as the target data fragment.

3. The method according to claim 2, wherein a duration of the target data fragment being longer than or equal to an occurrence duration of the traffic event.

4. The method according to claim 2, wherein the traffic event is related to the status information condition.

5. The method according to claim 1, wherein the one or more traffic participants include one or more of another mobile platform, a pedestrian, or an animal.

6. The method according to claim 1, wherein the control instruction further instructs the mobile platform to hover over the target path and/or move over the target path at a preset flight speed.

7. The method according to claim 1, wherein the control instruction instructs the mobile platform to move to above the target path in a preset time period.

8. The method according to claim 1, wherein the control instruction further instructs the mobile platform to move over the target path in a direction same as or opposite to a movement direction of one of the one or more traffic participants.

9. The method according to claim 1, wherein:
the mobile platform is one of a plurality of mobile platforms; and
the control instruction instructs the plurality of mobile platforms to move over the target path.

10. The method according to claim 9, wherein the control instruction instructs the plurality of mobile platforms to move to and hover at different locations over the target path.

11. The method according to claim 9, wherein the control instruction instructs the plurality of mobile platforms to move to above the target path at different time periods.

12. The method according to claim 9, wherein:
the plurality of mobile platforms includes a first mobile platform and a second mobile platform;
the control instruction instructs the first mobile platform to move to above the target path and to move in a direction same as a movement direction of one of the one or more traffic participants; and
the control instruction further instructs the second mobile platform to move to above the target path and to move in a direction opposite to the movement direction of the one of the one or more traffic participants.

13. The method according to claim 1, wherein the control instruction further instructs the mobile platform to adjust a sensing direction of the sensor to face the target path.

14. The method according to claim 13, wherein the sensor is coupled and mounted at a gimbal of the mobile platform, and the gimbal is configured to adjust the sensing direction of the sensor.

15. The method according to claim 1, wherein determining the status information of the one or more traffic participants includes:
preprocessing the survey data; and
determining the status information of the one or more traffic participants based on the preprocessed survey data.

16. The method according to claim 15, wherein:
the survey data includes a plurality of frames of image data; and
deviation between any two of the plurality of frames of image data after preprocessing satisfies a preset condition.

17. The method according to claim 1, further comprising:
performing target identification on the survey data to obtain one or more targets on the target path;
determining, based on the survey data, location information and speed information of each of the one or more targets; and
generating a traffic flow trajectory of the target path according to the location information and speed information of the each of the one or more targets.

18. The method according to claim 1, further comprising:
performing target identification on the survey data to obtain one or more targets on the target path; and
generating a scene map of the target path according to survey data of the one or more targets.

19. The method according to claim 1, further comprising:
generating a high-precision map of the target path based on the survey data.

20. The method according to claim 1, further comprising:
intercepting the target data fragment from the survey data, and storing the target data fragment.
